(19) United States
(12) Patent Application Publication
(10) Pub. No.: US 2015/0134367 A1
(43) Pub. Date: May 14, 2015

(54) System, Article, Method and Apparatus for Funding Life Insurance Premiums with Fixed Structured Settlements

(71) Applicant: Freshwater Holdings, LLC, Traverse City, MI (US)

(72) Inventor: Michael Ross Wittig, Traverse City, MI (US)

(73) Assignee: Freshwater Holdings, LLC, Traverse City, MI (US)

(21) Appl. No.: 14/074,763

(22) Filed: Nov. 8, 2013

(51) Int. Cl. G06Q 40/08

(52) U.S. Cl. CPC G06Q 40/08
USPC 705/4

(57) ABSTRACT

What is provided is a computer-implemented method, apparatus and article for funding life insurance premiums using one or more fixed structured settlements. A loan may be taken to fund an insurance policy, in an amount equal to a first premium payment for the life insurance policy and funds sufficient to purchase the fixed structured settlement to pay the total and subsequent scheduled premiums. The fixed structured settlement has returns of income payable in fixed amounts according to a payout schedule. The income from the fixed structured settlement may be paid to the loan, and then used to pay the insurance policy premium amounts that are due according to a premium schedule. The fixed structured settlement may be selected based upon having net income paid in amounts sufficient to meet the insurance policy premiums due and loan costs, with a payout schedule sufficient to meet the premium schedule.

### FIELD

This patent application relates to funding life insurance policy premiums.

### BACKGROUND

FIG. 1 shows how a life insurance policy typically may be funded with known methods. The insurance premium amount 100 includes the sum total of premiums due over time, according to a premium schedule. Premium amount 100 may be paid and/or financed with a loan 102. The loan 102 may be equal in amount to the insurance premium amount 100 and/or the insurance premium amount 100 plus loan interest, loan fees and/or other transaction costs. Loan 102 funds may be used to pay insurance premiums due in a single premium lump sum payment, and/or in two or more installments according to a premium schedule.

Loan 102 may be a commercial and/or private loan. Loan 102 may be made from a bank or other financial institution, and/or a private lender. Funding sources for loan 102 may typically include drawing upon life insurance policy benefits and/or outside sources. Life insurance policy benefits may include living and death benefits. For example, funding sources may include death benefit 104, refinancing 106, cash value loan 108 and/or out-of-pocket funds 110. Death benefit 102 is one manner of funding loan 102, where some or all of the monies to pay for the insurance premium amount 100 may be paid out of the life insurance policy death benefit, paid upon expiration (the death) of the insured. Refinancing 106 may be another method of funding loan 102, through a new loan or other funding source. Refinancing 106 may be used to pay some or all of premium amount 100, and typically may be used in combination with other funding sources after loan 102 has already begun to be used to pay premium amount 100. Loan 102 may also be funded through a cash value loan 108, which is a loan from the life insurance policy for up to its cash value amount (which generally varies over time, increasing over time). Finally, typically, loan 102 may be funded from out-of-pocket funds 110 and/or other assets available to the insured and/or policy owner. Out-of-pocket funds 110 may include cash, and/or a private loan used to fund loan 102, by way of example. Death benefit 104, refinancing 106, cash value loan 108 and/or out-of-pocket funds 110 may be used in various combinations to fund loan 102.

It has been known to use a secondary investment, such as an annuity, to fund life insurance premium payments. For example, as shown in FIG. 2, loan 102 may be funded using a premium reserve account annuity 112 or variable asset. Insured and/or policy owner monies may be used to purchase annuity 112, and the income 114 from annuity 112 may be used to fund loan 102 to pay insurance premium amounts 100, as they become due. Income 114 may be deposited in a premium deposit account 116 until such funds are used to fund loan 102 and/or income 114 may be used to purchase additional insurance coverage. Typically, a goal is to have income 114 is of a sufficient value to pay premium amount 100 as it comes due according to the premium schedule.

However, annuities and variable assets typically are tied to market interest rates and/or the stock market. As such, these funding sources are subject to market fluctuations and may not provide sufficient income 114 to meet loan 102 payments and/or insurance premium amounts 100 as they are due. Further, current insurance, banking, economic and finance laws and regulations, including the Frank Dodd Act, disallow variable assets to be used for premium reserve account 112. Current fixed interest rate annuities used to fund life insurance premiums typically include lower interest rate investments, such as bonds, which also may not yield income 114 sufficient to meet the amount of loan 102 and/or insurance premium amount 100 payments due to market conditions. As such, there exists a need in the industry for a different premium reserve account 112 funding source that is not tied to market interest rates or the stock market. There exists a need for a funding source having a fixed income, independent of market interest rates and the stock market.

### SUMMARY

What is provided includes a computer-implemented method, apparatus and article for life insurance premium funding using one or more fixed structured settlements. Fixed structured settlements provide a new asset class to fund a life insurance policy to decrease cost and increase cash value benefit of the life insurance policy. A loan may be taken to fund the insurance policy, in an amount equal to a first premium deposit payment for the life insurance policy and funds sufficient to purchase the fixed structured settlement asset. The fixed structured settlement has returns of income payable in fixed amounts according to a payout schedule. The income from the fixed structured settlement may be paid to the loan and is used to pay the insurance policy premium amounts that are due according to a premium schedule. The fixed structured settlement may be selected based upon having net income paid in fixed installment amounts sufficient to meet the insurance policy premiums due and loan costs, with a payout schedule sufficient to meet the premium schedule. A base Target premium with or without access premium may be used for the insurance policy premium amount, so as to provide cash value growth to the life insurance policy by the funding model. A premium may be selected that qualifies the life insurance policy as a non-modified endowment contract. A plurality of fixed structured settlement investments having the same and/or different fixed installment payment amounts and/or payout schedules may be used for the funding.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a system diagram showing an example of a prior known life insurance premium funding method;

FIG. 2 is a system diagram showing an example of a prior known life insurance premium funding method with an annuity or variable investment;

FIG. 3 is a system diagram showing an example of a life insurance premium funding method with a fixed structured settlement investment, in accordance with the present application;

FIG. 4 is a flow chart of an example of a method of identifying one or more fixed structured settlement investments that may be used to fund life insurance premium payments, in accordance with the present application;

FIG. 5 is a flow chart of an example method of managing funding of life insurance policy premiums with a fixed structured settlement, in accordance with the present application; and

FIG. 6 is an example computing system that may be used to tangibly embody and/or perform the methods of FIGS. 3-5.

### DETAILED DESCRIPTION

In the following detailed description, numerous specific details are set forth in order to provide a thorough understanding of the examples as defined in the claimed subject matter, and as an example of how to make and use the subject matter described herein. However, it will be understood by those skilled in the art that claimed subject matter is not intended to be limited to such specific details and may even be practiced without requiring such specific details. In other instances, well-known methods, procedures, and components have not been described in detail so as not to obscure the examples defined by the claimed subject matter.

Some portions of the detailed description that follow are presented in terms of flow chart processes, algorithms and/or symbolic representations of operations on data bits and/or binary digital signals stored within a computing system, such as within a computing platform and/or computing system memory. These descriptions and/or representations are the techniques used by those of ordinary skill in the data processing arts to convey the substance of their work to others skilled in the art. A flow chart process and/or algorithm is here and generally considered to be a self-consistent sequence of operations and/or similar processing leading to a desired tangible result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Though these descriptions are commonly used in the art and are provided to allow one of ordinary skill in this field to understand the examples provided herein, this application does not intend to claim subject matter outside of the scope of 35 U.S.C. 101, and claims and claim terms herein should be interpreted to have meanings in compliance with this statute's requirements.

Unless specifically stated otherwise, as apparent from the following discussion, it is appreciated that throughout this specification discussions utilizing terms such as “processing”, “computing”, “calculating”, “determining” , “identifying” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that instructs may mean to direct or cause to perform a task as a result of a selection or action by a user. A user may, for example, instruct a computing platform to embark upon a course of action via an indication of a selection, including, for example, pushing a key, clicking a mouse, maneuvering a pointer, touching a touch screen, and/or by audible sounds. A user may, for example, input data into a computing platform such as by pushing a key, clicking a mouse, maneuvering a pointer, touching a touch pad, touching a touch screen, acting out touch screen gesturing movements, maneuvering an electronic pen device over a screen, verbalizing voice commands and/or by audible sounds.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure. To this end, many well-known techniques and design choices are not repeated herein so as not to obscure the teachings of this disclosure. Those of ordinary skill will appreciate that there are many ways to code functionality described in flow charts in many various computing languages and using various computing protocols. Claimed subject matter is not intended to be limited to a particular computer language or coding of the processes and subject matter described herein. Those of ordinary skill will appreciate that functionality or steps described in flow charts may be implemented using different orders of steps or actions from those specifically shown in the flow charts, unless specifically stated otherwise. Those or ordinary skill will appreciate that flow charts may not include all processes that may be used within the scope and spirit of the present application, but merely provide single examples of one manner of practicing the subject matter disclosed herein. Other processes and/or additions to processes disclosed are possible within the scope and spirit of this application.

Throughout this specification, the term system may, depending at least in part upon the particular context, be understood to include any method, process, apparatus, and/or other patentable subject matter that implements the subject matter disclosed herein.

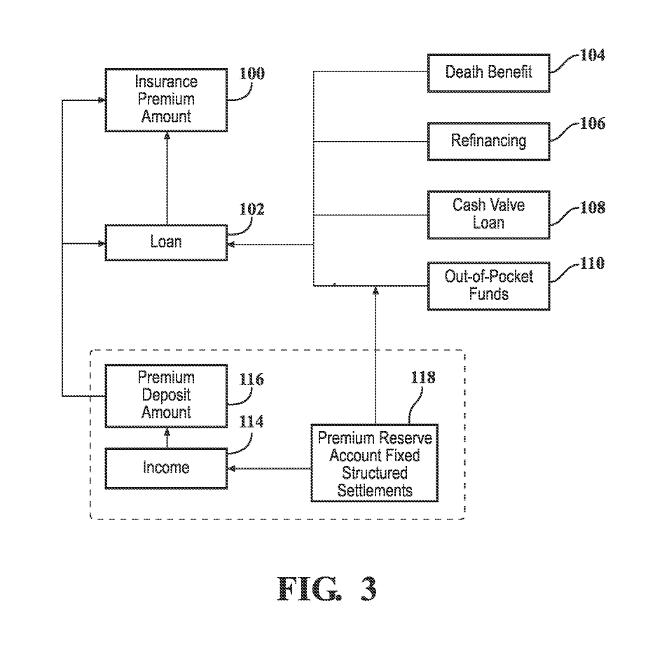

As shown in FIG. 3, what is provided is a premium reserve account of fixed structured settlement 118 funds that may be used to fund loan 102 and/or insurance premium amount 100. Income 114 produced by fixed structured settlements 118 may be paid into premium deposit account 116. Income 114 may include fixed structured settlement payments that mature according to a payment schedule. Income 114 consists of fixed installment payments that do not fluctuate in amount with market interest rates or changes in the stock market. Fixed structured settlements 118 may be purchased by the insured and/or policy owner with out-of-pocket funds, a private loan and/or other assets, and used as an investment used to fund loan 102 and/or insurance premium payments 100. In various examples, loan 102 may include premium deposit account 116 and/or premium deposit account may be separate from loan 102.

A fixed structured settlement 118 is an asset or income settlement with guaranteed fixed installments. It may be a plurality of fixed structured settlements 118 in a portfolio. The plurality of fixed structured settlements 118 may have the same or different income payout amounts and/or payout schedules. An example of a fixed structured settlement 118 is a pension income stream. Unlike other prior known premium reserve account 116 investment sources, fixed structured settlements 118 do not fluctuate in amount due to changes in the initial offering rate or market interest rates and/or stock market. Fixed structured settlements are offered to the market by an acceptable offer of the individual or entity selling the benefit or income stream, rather than an industry linked rate as like in an annuity. Rather, fixed structured settlements 118 provide a fixed income amount, payable at payout intervals according to a payout schedule. They do not have a term with a maturity date as such as bonds or certificates of deposit. In various examples, fixed structured settlement 118 funds may have a schedule such that a payment comes due on or before the due date of loan 102 and/or insurance premium amount 100 payment due dates.

Generally speaking, amount of the fixed structured settlement 118 is fixed, and to be paid over time in fixed payments or payouts set according to the payment schedule. As such, there does not exist the uncertainty of a payment amount, which exists with annuities and variable assets. Fixed structured settlements 118 are not correlated to the interest rate market or stock market. Fixed structured settlements 118 may provide a greater positive arbitrage than currently used premium reserve account 116 investments with guarantee. Other examples of fixed structured settlements 118 may include, but are not limited to, a portfolio of civil litigation settlements, lottery payments, life insurance death benefits, royalties, and other fixed income streams. Various fixed structured settlements 118 may have different maturity timeframes and different payment schedules.

Rather than using policy owner funds to fully fund the life insurance policy upon its issuance, the money is instead used to invest in the fixed structured settlement 118. In one or more examples, the fixed structured settlement 118 provides income greater than the funds spent to purchase it, and in that manner, provides a fixed guaranteed asset for an anticipated positive cash flow and may serve to reduce collateral required for the financing and/or increase a cash value of the life insurance policy.

In one or more examples, fixed structured settlement 118 funds may mature and/or be paid in full by 3 to 10 years after purchase, and have a fixed payment schedule of 3 to 10 years, which allow for greater funding efficiency, policy cash value growth potential and a collateralization ratio that a lender may require for such a loan. In at least one example, a fixed structured settlement 118 used with the present method may mature in less than 10 years.

Once the fixed structured settlement 118 matures/expires, the remaining income 114 may be paid to the insured and/or policy owner, held in the premium deposit account 116 to pay future loan 102 payments and/or premium amounts 100 as they are due, and/or used to purchase additional life insurance benefit. In some examples, the fixed structured settlement 118 has a zero dollar balance (or a negligible balance) upon payment in full of the life insurance policy. In one or more examples, the life insurance policy is funded in 3-10 years by the fixed structured settlement. In various examples, the method of FIG. 3, using a fixed structured settlement 118 to fund one or more life insurance policy premium amounts 100, may be used alone and/or in conjunction with other funding options, such as but not limited to, death benefit 104, refinancing 106, cash value loan 108 and/or out-of-pocket funds 110.

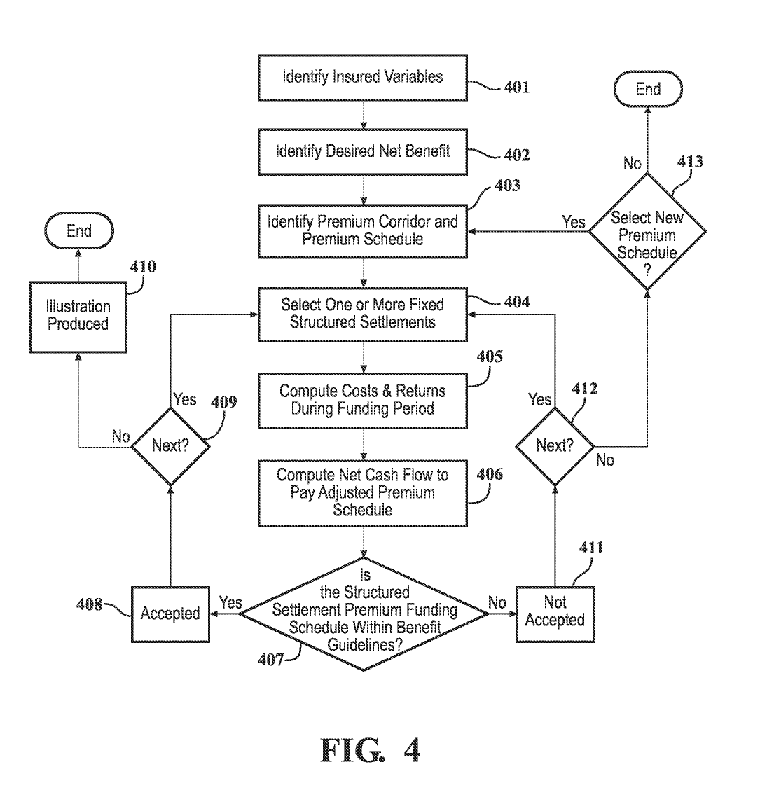

FIG. 4 shows a method of funding insurance premium amount 100 with a premium reserve account 116 funded with a fixed structured settlement 118, according to the present application. At 401, one or more insured variables may be identified. Insured variables may include, but are not limited to, a health class rating of the insured, which may include factors such as: age; sex; previous and current health conditions; and whether the insured is a smoker. The method may include accepting this data, as manually input, and/or retrieving it from one or more databases storing the data in memory. Identification of insured variables is optional.

At 402, a desired net benefit is identified. The desired net death benefit is the benefit amount net of the repayment of any outstanding collaterally assigned loans to fund the life insurance policy. The method may include accepting this data, as manually input, and/or retrieving it from one or more databases storing the data in memory. The desired net death benefit amount may include a death benefit amount that the insured and/or policy owner seeks overall. It may include a death benefit alone, or an amount sufficient to cover repayment of one or more loans used for acquiring the policy and a death benefit. Identification of desired net death benefit is optional.

Other examples may not include identifying insured variables and/or desired net death benefit. This information may have been pre-determined and instead merely communicated to, or retrieved or received by, a computing system performing the method of FIG. 4. As used herein, “identify” may include, but is not limited to, computing, calculating, receiving, retrieving, determining, looking up, performing a searching function to ascertain, and the like.

At 403, one or more premium corridors and/or premium schedules is identified. A premium corridor defines a range of the minimum and maximum amounts that may be used to pay for the life insurance benefit according to one or more different premium schedules. A premium corridor identifies an amount to pay within a set time period to fund the policy. Various factors and past, current and/or future laws and regulations known in the industry may be used to identify, determine and/or calculate one or more premium corridors and/or premium schedules available. For example, various government set insurance regulations and law may be used to determine the shortest or longest funding period allowed for a policy at a minimum and maximum cost of insurance, different payment time periods, the maximum or minimum premium amounts due under the various time periods, and/or a single premium payment amount.

The method may include identifying, determining or calculating a minimum amount of monthly and/or annual premium amount to maintain the life insurance policy for a specific amount of time. For example, the premium corridor may identify the minimum amount of premium amount to keep the life insurance policy in force for 20 years. This is merely but one example possible within the scope and spirit of the present application.

The method may include identifying, determining or calculating a target premium. A target premium includes an additional premium amount, above the minimum guarantee and/or the minimum premium required to maintain the life insurance policy, which may be used to keep the life insurance policy in force longer, provide potential cash value accumulation and/or interest earnings that may be used to pay policy costs and/or borrowed funds, or may be loaned out as a cash value loan on the life insurance policy and used as collateral for a loan. This is an overpayment of the base premium, which may allow some cash value growth for the life insurance policy. A target premium may be used to pay greater than the minimum required amount and/or pay one or more premium amounts earlier than they are due according to the premium schedule, so as to increase the cash value of the life insurance policy. In one example, a target premium may be identified annually over the life of the policy.

The method may include identifying, determining or calculating a guideline level, which is a ceiling of how much premium can be paid annually for the life insurance policy. This amount may be based upon past, current and/or future insurance laws and regulations, such as but not limited to, the Tax Equity and Fiscal Responsibility Act of 1982 (TEFRA), Deficit Reduction Act of 1984 (DEFRA), Technical and Miscellaneous Revenue Act of 1988 (TAMRA), and the like, which may provide government set minimum cost for a life insurance policy for insurance per dollar contributed, a maximum amount that an insured and/or policy owner pays for the coverage per life, and/or other government set requirements and regulations for life insurance policies and life insurance policy related investments. A guideline premium is the maximum premium that can be paid on a linear frequency every year for life or as long as the interest accreditation growth less costs of the policy will allow it to stay in force. This will add additional cash value accumulation being higher than the target premium but not exceeding the maximum value allowed to maintain tax favored treatment under tax laws, including TEFRA, DEFRA and TAMRA.

The method may include identifying, determining or calculating a maximum annual premium that may be paid to keep the life insurance policy qualified, according to the TAMRA 7-Pay Test and/or other current and/or future insurance laws and regulations. For example, the 7-Pay Test may be used to calculate maximum annual premium that may be paid to allow the life insurance policy to be classified as a non-modified endowment contract. The 7-Pay Test is known in the industry, and includes various algorithms, formulas, and/or determinations, which may be implemented by various examples. A description of such algorithms, formulas and/or determinations of the 7-Pay Test may be found at http://www.nongnu.org/lmi/7702.html and a description of modified endowment contracts and the 7-Pay Test may be found at http://www.thewpi.org/?a=PG:926.

The method may include calculating a single premium amount, for paying the entire policy premium with a single payment.

In identifying, determining and/or calculation the premium corridor, in one ore more examples, a goal may be to reduce and/or minimize cash idle time such that the life insurance premium is paid in a shortest amount of time possible, and/or identifying, determining and/or calculating the premium corridor and schedule so that the fixed structured settlements to have a fixed payment amount and payment schedule to payoff close to the premium amount and schedule.

The method includes identifying, determining and/or calculation one or more premium schedules which provide a schedule for how much premium to pay at what interval(s) of time. The premium schedule may be set according to maximum and/or minimum thresholds within the premium corridor, such as a maximum amount that a policy insured and/or owner can pay per month.

At 404, one or more fixed structured settlements 118 (as described with reference to FIG. 3) is selected that is capable of yielding income to pay the life insurance premium payments due according to the premium schedule identified at 403. Various fixed structured settlements 118 may be selected to meet and/or maximize the insurance corridor identified at 403.

Fixed structured settlements 118 selected at 404 may consist of one or more fixed structured settlements 118 with varying income dates, terms and maturity. In some examples, the fixed structured settlements 118 may include a fixed income asset portfolio of fixed structured settlements 118 with varying fixed rates, terms and income payment dates. In some examples, all terms may reach maturity within one year of the last scheduled premium payment date, according to the premium schedule, identified at 403. In various examples, the one or more fixed structured settlements 118 selected at 404 are computed such that income produced by the settlement(s) meets or exceeds the amount of loan 102 and/or the premium amount 100 (as described with reference to FIG. 3), for the time period and frequency of payment of the premium schedule identified at 403.

In one or more examples, the fixed structured settlements 118 may be selected for paying subsequent premium payments to be due after an initial deposit payment. The initial premium payment may be made from loan funds borrowed. Other examples may include paying some or all of the premiums due over time. The method may include retrieving and/or performing a look-up and/or search function to retrieve fixed structured settlement 118 options from a database. The database may contain an inventory of various fixed structured settlement 118 investment options. Such a database may be integral within the computing system implementing this method and/or external to and in remote communication with the system.

The method of FIG. 4 includes selecting one or more fixed structured settlements 118 based upon its payout timing and amount, so as to identify a fixed structured settlement 118 that at least meets the premium corridor and/or schedule identified at 403. The fixed structured settlement income 114 may be used to repay or fund the loan, the loan may be used to pay the premiums due according to the premium schedule. The method may include selecting one or more fixed structured settlement 118 options to optimize the premium corridor and/or premium schedule identified at 403. For example, the method may provide a fixed structured settlement 118 investment option that pays out fixed installment income 114 at or before the payment due date for the life insurance premium in an amount equal to or greater than the premium amount according to the premium corridor.

The method may optionally include generating, producing, displaying, printing and/or exporting a report of the fixed structured settlement 118 options that meet the premium corridor and schedule criteria, and/or a ranked listing of such fixed structured settlements 118 that optimize the premium corridor and/or schedule.

In one or more examples, the method may optionally include reserving a fixed structured settlement 118 investment for purchase, to provide a commit to purchasing the asset and/or a locked-in investment choice. Other examples may include purchasing the fixed structured settlement 118, such as by communicating electronic purchase instructions from a computing platform of a system user to an owner of the asset to execute the purchase.

At 405, the costs and returns are computed during the funding period. Costs computed at 405 include loan costs, such as but not limited to, interest rate costs, service fees and the like. In some examples, costs may include life insurance policy costs such as administration of management fees, policy fees and the like. However, in other examples, insurance policy costs may be accounted for with insurance policy benefit and/or premium amounts presented by the insurer, such as by being accounted for with the desired benefit identified at 402 (identified as a net benefit) and/or with the premium corridor and/or schedule identified at 403. In some examples, costs calculated at 405 may include fixed structured settlement 118 investment costs. However, in other example, fixed structured settlement 118 costs may be accounted for with the fixed structured settlements 118 selected at 404, such as by the purchase price and/or the fixed installment payment amounts, such that net numbers are used for investment options to be selected.

Returns computed at 405 may include a funding return for the asset to be servicing the loan—the fixed structured settlement 118. Returns may include the insurance policy return, comprising the benefit to be paid out and/or a policy cash value. This may be based upon minimum and current assumptions provided by the insurance carrier, such as but not limited to, cash value growth and benefit amount. Returns may be based off of the net value of the cost of funding, growth of policy cash value, with an average interest rate, the fixed structured settlement 118 return with its fixed payout amount, and/or any additional positive or negative return of idle premium deposit/cash account (interest paid, service fees out, etc.). In some examples, the funding period may be 10 years or less.

In accordance with the method, at 406 the net cash flow to pay the adjusted premium schedule is computed. This produces a schedule of premium amounts 100 due at what time intervals, which establishes a schedule of funds needed at the set time intervals, for meeting the premium payments. The net cash flow includes an accounting for loan costs, fixed structured settlement payouts made according to the payout schedule (which serve as income 114) and life insurance premium amounts 100 due according to the premium schedule.

At 407, it is determined whether the fixed structured settlement premium funding schedule is within the benefit guidelines. This determines whether the fixed structured settlement payouts meet the life insurance policy premium amounts 100 due at each payment interval computed at 406. At 407 it is determined whether the fixed structured settlement payout meets the life insurance policy premium amount 100 and schedule. If the fixed structured settlement 118 meets the premium amount and schedule, then the fixed structured settlement 118 investment is accepted at 408. It may be added to a listing of accepted fixed structured settlement 118 funding options. At 409, the method includes inquiring as to whether there exist any other fixed structured settlement 118 funding options. If more options exist, then the method returns to 404 to select the next fixed structured settlement 118 investment, and the method repeats the process for determining whether the next fixed structured settlement 118 is accepted. If there do not exist any further fixed structured settlement 118 investment options to analyze, at 410, an illustration may be produced of the listing of fixed structured settlements 118 that meet benefit guidelines. The illustration may include a listing of one, more or all available fixed structured settlement 118 options accepted at 408. The illustration may optionally include a ranked weighting of fixed structured settlement 118 investment options, such as options ranked by an optimization of premium corridor and/or premium schedule. Fixed structured settlements 118 may also be ranked by various other criteria, such as minimum payout amounts, maximum payout amounts, and other criteria.

The method may optionally include generating a report of fixed structured settlement 118 options accepted at 408, displaying the listing and/or report on a graphical user interface (GUI), printing the report or listing, saving the report or listing to memory and/or in a database, and/or exporting, emailing, messaging or otherwise communicating the listing and/or reporting it to another system, user, agent, insurer, lender, policy insured, policy owner and/or third party.

If the fixed structured settlement 118 investment option does not meet benefit guidelines at 407, the fixed structured settlement 118 investment option is rejected at 411. It may be added to a listing of options that are rejected and/or not accepted at 411. At 412, there is an inquiry as to whether there are any further fixed structured settlement 118 investment options. If more options exist, then the method returns to 404 to select the next fixed structured settlement 118 investment option for analysis. If there are not any further fixed structured settlement 118 options that had been selected at 404, then the method may select a new premium schedule at 413 and return to 403. Based upon the new premium schedule, the method may include selecting one or more fixed structured settlement 118 investment options to meet this new schedule at 404. In other examples, a new premium corridor may be selected upon returning to 403 and the method may include selecting one or more fixed structured settlement 118 investment options to meet this new corridor at 404. If no new premium schedule and/or corridor is selected at 413, the method ends.

In various examples, the method may include reviewing one, some or all possible fixed structured settlement 118 options available in the database. In one example, the method may stop analyzing possible fixed structured settlement 118 options upon finding a first option that is within the benefit guidelines. Other examples may include analyzing each fixed structured settlement 118 investment option to produce a listing of all available options. Other examples may optionally include providing a listing or report of each fixed structured settlement 118 investment option that does not meet benefit guidelines, and/or provide further information for one, more or each such investment option such as but not limited to how far the investment option is outside of the benefit guidelines. Such information may be used to set a new premium schedule and/or corridor at 403.

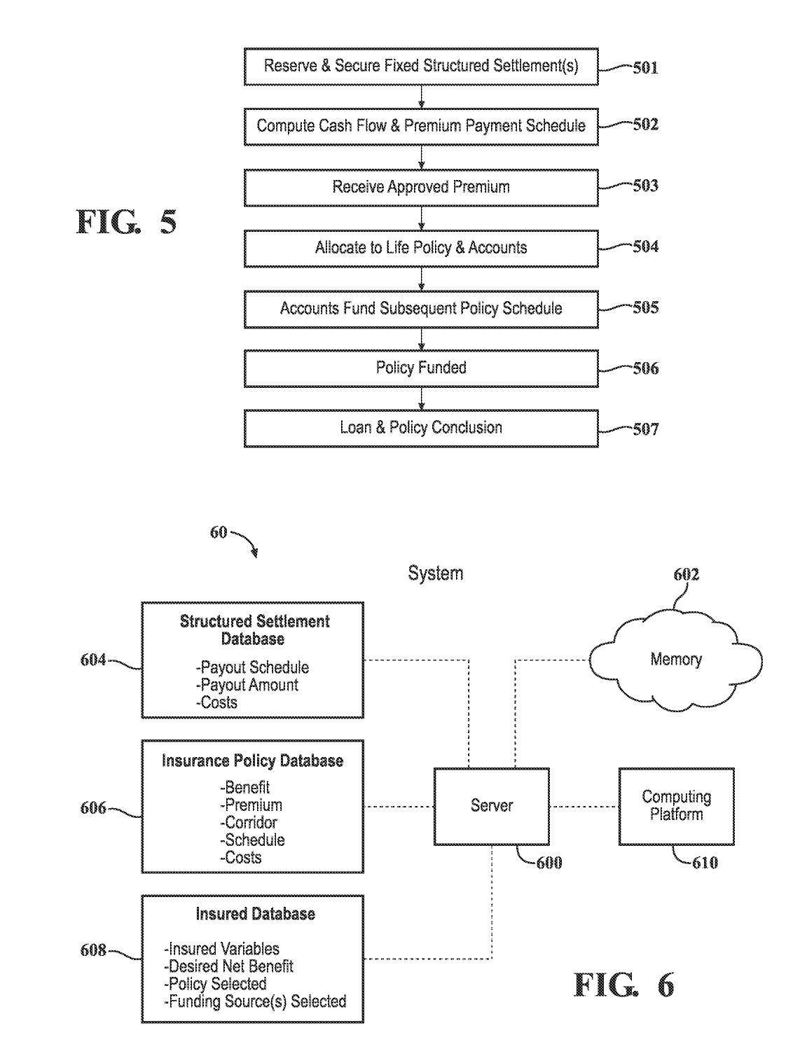

FIG. 5 shows a method for managing life insurance premium funding using a fixed structured settlement 118, in accordance with the present application. Block 501 depicts that a fixed structured settlement 118 is reserved and/or secured for use as a funding source. For example, one of the investment options accepted at 408 described with respect to FIG. 4 above, may be reserved and/or locked-in for use for the funding model. The fixed structured settlement 118 may be purchased. For example, the accepted fixed structured settlement 118 may be purchased using the loan funds by sending electronic purchase instructions from a computing platform to a remote computing platform of an owner or servicer of the fixed structured settlement.

At block 502, the method includes computing the cash flow and premium payment schedule for funding the life insurance policy premium payments using the selected fixed structured settlement 118. In other examples, this information may be imported from data stored regarding the method performed of FIG. 4—specifically from the data produced at block 406.

At block 503, funds sufficient to pay the premium amount may be received from the fixed structured settlement 118 investment. The funds may be allocated to the life insurance policy premium amount 100 due at block 504. The funds may be paid to a loan 102 that is used to pay the premiums due and/or to the life insurance policy directly. As shown in FIG. 3, this income 114 may be held in premium reserve account 116 until due and/or paid directly to repay loan 102 and/or make the premium amount 100 payment.

For example, the fixed structured settlement income 114 may be paid to the loan according to the pay-out schedule by sending electronic payment instructions from a computing platform to a remote computing platform of an owner or servicer of the loan, and the portions of the premium amount 100 due according to the premium schedule may be paid with the loan funds from the fixed structured settlement income 114 by sending electronic payment instructions from a computing platform to a remote computing platform of the owner or servicer of the life insurance policy.

As shown by block 505, this process is repeated as each life insurance premium amount 100 becomes due, according to the premium schedule. The process is repeated until the policy is funded, at block 506. Block 507 shows that the loan 102 is concluded upon policy funding at block 506. Block 507 also shows that in some examples, the policy may be concluded upon policy funding at block 506.

FIG. 6 shows an example of a system that may be used to tangibly embody one or more methods of FIGS. 3-5. System 60 may include server 600. Server 600 may include a processor and/or memory and is capable of web-based or other remote communication with one or more computing platforms 610. Server 600 may be in local and/or remote communication with memory 602 and/or databases 604, 606 and 608. The processor of server 60 may be capable of executing electronically stored instructions to perform one or more methods of FIGS. 3-5.

Server 600 may include a web server, which may be used to communicate with one or more computing platforms 610 and/or user devices remotely over a network. Communication networks may be any combination of wired and/or wireless LAN, cellular and/or Internet communications and/or other local and/or remote communications networks known in the art.

Server 600 has one or more processors capable of performing tasks, such as all or a portion of the methods described with respect to FIGS. 3-5, as described herein. Server 600 is in communication with and/or has integral memory 602 in one or more examples. Memory 602 may be any type of local, remote, auxiliary, flash, cloud or other memory known in the art. In some examples, one or more user devices or other systems may send data to server 600 via a network for storage in memory 602, such as database information for one or more of databases 604, 606 and/or 608, or other information.

System 60 includes and/or is capable of communication with a structured settlement database 604, which contains data regarding fixed structured settlement investment options. For example, structured settlement database 604 may contain different fixed structured settlement investment options, payout schedule, payout amount and cost information for one or more fixed structured settlements. As described at block 404 of FIG. 4, structured settlement database 604 may be accessed by server 600 to select one or more fixed structured settlements. In other examples, system 60 may not include, but may access a third party structured settlement database 604. For example, structured settlement database 604 may be maintained, updated, edited and/or hosted by an investment broker or other entity.

System 60 may include and/or is capable of communication with insurance policy database 606. Insurance policy database 606 may be used to store data regarding various insurance policies, such as but not limited to, policy benefit, premiums, premium corridor(s), premium schedule(s) and costs. Server 600 may be used to identify, calculate or compute premium corridor and/or schedules as described at block 403 of FIG. 4 using data from insurance policy database 606. In other examples, system 60 does not include insurance policy database 606, but instead may remotely communicate with a separate and/or third party database of such information. For example, insurance policy database 606 may be maintained, edited and/or hosted by a third party insurance company and remotely accessed by system 60.

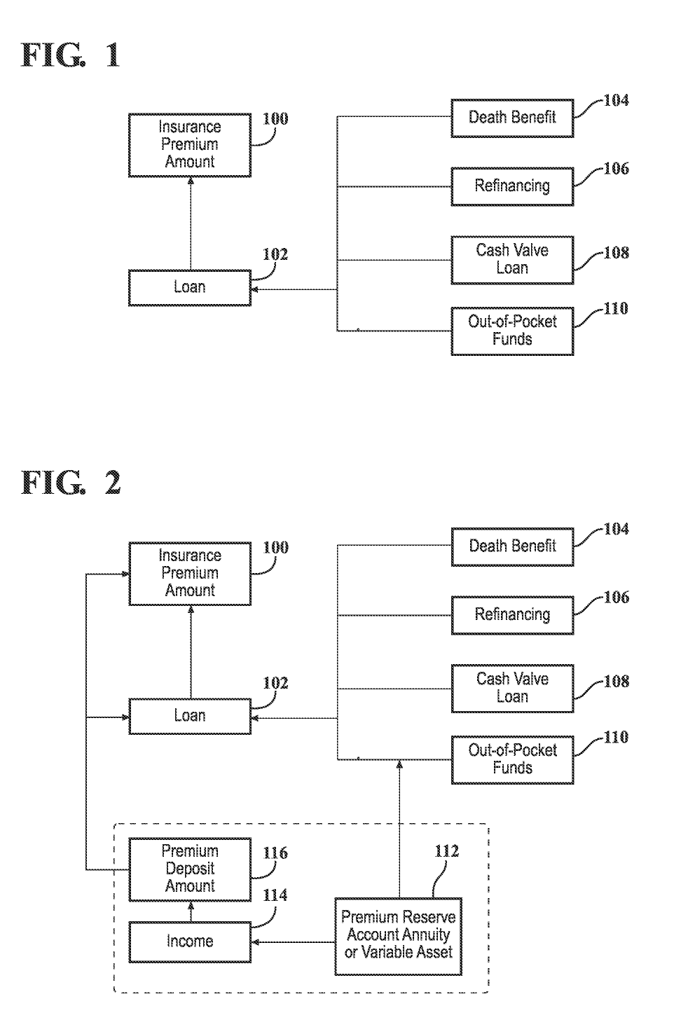

System 60 may contain and/or be in communication with insured database 608, which may include data regarding a policy insured and/or policy owner. For example, insured database 608 may include data such as but not limited to, insured variables (that are identified at block 401 of FIG. 4), desired net benefit (identified at block 402 of FIG. 4), a life insurance policy selected, funding source(s) selected (such as a fixed structured settlement that may be held in a premium reserve account 118 of FIG. 3). In some examples, insured database 608 may contain data regarding other funding sources such as death benefit 104, refinancing 106, cash value loan 108 and/or out-of-pocket funds 110, described above with regard to FIGS. 1-3. In other examples, system 60 does not include insured database 608, but instead is capable of remote communication with a separate and/or third party database of such information. For example, insured database 608 may be maintained, edited and/or hosted by a third party insurance broker and remotely accessed by system 60.

Insured database 608 may be accessed by server 600, such as but not limited to, for identifying insured variables at block 401 of FIG. 4, identifying desired net benefit at block 402 of FIG. 4, and/or storing data for illustrations produced at block 410, a listing or report of fixed structured settlements accepted at block 408 and/or not accepted at block 411, of FIG. 4.

In various examples, databases 604, 606 and/or 608 may be separate databases and/or one or more of databases 604, 606 and/or 608 may be combined. Those skilled in the art will appreciate that database structure may vary according to known techniques.

One or more computing platforms 610 may be included in system 60. They may be used to perform the functions of and tangibly embody the article, apparatus and methods described herein, such as those described with reference to FIGS. 3-5, although the scope of claimed subject matter is not limited in this respect. Computing platform 610 may be utilized to embody tangibly a computer program and/or graphical user interface, such as a web portal, by providing hardware components on which the computer program and/or graphical user interface may be executed. Computing platform 610 may be utilized to embody tangibly all or a portion of FIGS. 3-5 and/or other methods or procedures disclosed herein. Such a procedure, computer program and/or machine readable instructions may be stored tangibly on a computer and/or machine readable storage medium such as a flash memory, cloud memory, compact disk (CD), digital versatile disk (DVD), flash memory device, hard disk drive (HDD), and so on. Memory may include one or more auxiliary memories. Memory may provide storage of instructions and data for one or more programs to be executed by the processor, such as all or a portion of FIGS. 3-5 and/or other procedures disclosed herein. Various types of memory are possible, such as by way of example, semiconductor-based memory such as dynamic random access memory (DRAM) and/or static random access memory (SRAM), synchronous dynamic random access memory (SDRAM), Rambus dynamic random access memory (RDRAM), ferroelectric random access memory (FRAM), and so on. Alternatively or additionally, memory may comprise magnetic-based memory (such as a magnetic disc memory or a magnetic tape memory); an optical-based memory (such as a compact disc read write memory); a magneto-optical-based memory (such as a memory formed of ferromagnetic material read by a laser); a phase-change-based memory (such as phase change memory (PRAM)); a holographic-based memory (such as rewritable holographic storage utilizing the photorefractive effect in crystals); a molecular-based memory (such as polymer-based memories); and/or a remote or cloud based memory and/or the like. Auxiliary memories may be utilized to store instructions and/or data that are to be loaded into the memory before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM, and/or non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and others. Other varieties of memory devices and their future developments are contemplated as well, and claimed subject matter is not intended to be limited to this one possible tangible memory medium.

Computing platform 610 may be controlled by a processor, including one or more auxiliary processors. For example, the method of FIG. 4 described above may be performed, at least in part, by use of a processor. A processor may comprise a central processing unit (CPU) such as a microprocessor or microcontroller for executing programs, performing data manipulations, and/or controlling the tasks of the computing platform. Auxiliary processors may manage input/output, perform floating point mathematical operations, manage digital signals, perform fast execution of signal processing algorithms, operate as a back-end processor and/or a slave-type processor subordinate to a processor, operate as an additional microprocessor and/or controller for dual and/or multiple processor systems, and/or operate as a coprocessor and/or additional processor. Auxiliary processors may be discrete processors and/or may be arranged in the same package as a main processor, such as by way of example, in a multicore and/or multithreaded processor. Claimed subject matter is not limited by a specific processor example of a specific computing platform example.

Communication with a processor may be implemented via a bus for transferring information among the components of computing platform 610. A bus may include a data channel for facilitating information transfer between storage and other peripheral components of computing platform 610. A bus may further provide a set of signals utilized for communication with a processor, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100 and later developed standards. Claimed subject matter is not limited to these particular examples.

Computing platform 610 further may include a display for displaying the illustration of 410 and/or the listings and reports described with respect to FIG. 4 above. It may display a web portal or GUI of system 60. The display may comprise a video display adapter having components, including video memory (such as video random access memory (VRAM), synchronous graphics random access memory (SGRAM), windows random access memory (WRAM) and others), a buffer, and/or a graphics engine. The display may comprise a cathode ray-tube (CRT) type display such as a monitor and/or television and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and any others known in the art. The display may be a touch screen display. The display may be used to view illustrations, report and listings of the present system, article, apparatus and methods, described with reference to FIG. 4 above.

Computing platform 610 further may include one or more I/O devices, such as a keyboard, touch screen, stylus, electroacoustic transducer, microphone, speaker, audio amplifier, mouse, pointing device, bar code reader/scanner, infrared (IR) scanner, radio-frequency (RF) device, and/or the like. The I/O devices may be used for inputting data, such as claims information, into the system. There may be an external interface, which may comprise one or more controllers and/or adapters to prove interface functions between multiple I/O devices, such as a serial port, parallel port, universal serial bus (USB) port, charge coupled device (CCD) reader, scanner, compact disc (CD), compact disk read-only memory (CD-ROM), digital versatile disc (DVD), video capture device, T tuner card, 802x3 devices, and/or IEEE 1394 serial bus port, infrared port, network adapter, printer adapter, radio-frequency (RF) communications adapter, universal asynchronous receiver-transmitter (UART) port, and newer developments thereof, and/or the like, to interface between corresponding I/O devices.

As used herein, computing platform 610 and computer readable storage media do not cover signals or other such unpatentable subject matter. Only non-transitory computer readable storage media is intended within the scope and spirit of claimed subject matter.

Computing platform 610 may include more and/or fewer components than those discussed herein. Claimed subject matter is not intended to be limited to this particular example of computing platform 610 that may be used with the system, article and methods described herein.

The one or more computing platforms 610 of system 60 may be local and/or remote communication with server 600 and/or memory 602. For example, various computing platforms 610 may be used to access data of system 60, display and/or store in memory illustrations, listings and/or report produced by system 60 upon performing the method of FIG. 4. Various system users may use computing platforms 610 to perform or view the results of performing the methods of FIGS. 3-5. Various system users may include insurance companies, insurance agents, insurance brokers, insured, policy owners, lenders, fixed structured settlement providers and others.

Server 60 may provide a web portal, GUI or other display that is viewable upon computing platform 610. Computing platform 610 may be used to input data, such as insured information, policy owner information, policy information, structured settlement investment information and/or other information. The user device may be a computing platform, such as a computing device, desktop computer, laptop computer, tablet, mobile device, handheld device, PDA, cellular device, smartphone, scanner or any other device known in the art that is capable of being used to input data, such as into a web based portal. The user device may be capable of accepting user input or electronically transmitted data. The user device may be used to upload data to server 600 via a network. Various users may operate different computing platforms within system 60. Users of system 60 may communicate with users outside of system 60 by sending electronic communications to users outside of system 60. For example, a user of system 60 may use computing platform 610 to send electronic purchase instructions to an owner or servicer of a fixed structured settlement asset to purchase it. For example, a user of system 60 may use computing platform 610 to send electronic payment instructions to an owner or servicer of the life insurance policy, to pay premium amounts due, from loan amounts funded by fixed structured settlement income. For example, a user of system 60 may use computing platform 610 to send electronic payment instructions to a servicer of the fixed structured settlement asset to pay income from the fixed structured settlement to the loan and/or to pay insurance policy premiums. For example, a user of system 60 may use computing platform 610 to send electronic payment instructions to an owner or servicer of the loan to receive income from the fixed structured settlement and/or pay life insurance premiums due. These are merely but new of the many possible examples of communications possible to third parties outside of system 60. In other examples, the users described herein as outside of system 60 may be included within system 60.

It will, of course, be understood that, although particular examples have just been described, the claimed subject matter is not limited in scope to a particular example or implementation. For example, one example may be in hardware, such as implemented to operate on a device or combination of devices, for example, and another example may be in software. Likewise, an example may be implemented in firmware, or as any combination of hardware, software, and/or firmware. Another example may comprise one or more articles, such as a storage medium or storage media such as one or more SD cards and/or networked disks, which may have stored thereon instructions that if executed by a system, such as a computer system, computing platform, or other system, may result in the system performing methods and/or displaying a user interface in accordance with claimed subject matter. Such techniques may comprise one or more methods for electronically processing the methods for funding life insurance premiums with fixed structured settlements functionality described herein.

It should be noted that setting aside current insurance regulations and law (that do not allow for a variable asset to be used to fund life insurance policy premiums), variable structured settlements could be used as an alternate funding model in accordance with another example of the present method, apparatus and article. Of course, banking, finance and insurance laws and regulations may change over time. The present method, apparatus and article are not dependent upon current banking, finance and insurance laws or market conditions to operate for their intended purposes; may be performed with future different laws and regulation; and may operate independent of compliance with such laws and regulations that may restrict use for different reasons. Applicant does not warrant or guarantee compliance with such insurance, banking, tax or finance laws and regulations, but provides a life insurance premium funding method, apparatus and article that may operate for its intended purpose, even if not commercially viable due to outside prohibitions established in such laws or regulations.

In the preceding description, various examples of the present methods, apparatus and article have been described. For purposes of explanation, specific examples, numbers, systems, platforms and/or configurations were set forth to provide an understanding of claimed subject matter. Computer file types and languages, and operating system examples, to the extent used, have been used for purposes of illustrating a particular example. However, it should be apparent to one skilled in the art having the benefit of this disclosure that claimed subject matter may be practiced with many other computer languages, operating systems, file types, and without these specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art, particularly with reference to the specific computing platform example described herein. The present system, article and method may be tangibly embodied with other computing platforms and future developments thereto. This application is not intended to be limited to the particular computer hardware, functionality and methodology described herein, and is not intended to cover subject matter outside of the limitations to patentability set by 35 U.S.C. 101.

1. An article comprising: a non-transitory computer readable storage medium having stored thereon instructions that, if executed, enable a computing platform to:
select a life insurance policy having a net benefit, based upon one or more insured variables qualifying an insured for the life insurance policy;
for the insurance policy, identify a premium schedule comprising one or more due dates for payment of a portion of a premium amount, identify a premium corridor comprising a range of minimum and maximum amounts of the premium portions due according to the premium schedule, and set the premium amount within the premium corridor;
select one or more fixed structured settlements having income that is payable in fixed installments according to a pay-out schedule, the fixed structured settlement comprising an asset that does not fluctuate in amount due to changes in an initial offering rate or market interest rates and/or stock market rates;
calculate costs of a loan having funds sufficient to pay a first premium amount due according to the premium schedule and a purchase price of the fixed structured settlement;
calculate returns of the fixed structured settlement income to be paid according to the payout schedule;
calculate a net cash flow of the loan costs, returns of the fixed structured settlement income and the premium amount due according to the premium schedule; and
if the fixed structured settlement income is greater than or equal to the loan costs and premiums due according to the premium schedule, and payable according to the pay-out schedule on or before the premium schedule due dates, approve the fixed structured settlement.

2. The article of claim 1, having further stored thereon instructions that, if executed, enable a computing platform to:
if the fixed structured settlement income is less than the loan costs and premiums due according to the premium schedule or payable according to the pay-out schedule after the premium schedule due dates, reject the fixed structured settlement.

3. The article of claim 1, having further instructions stored thereon that, if executed, enable a computing platform to:
produce an illustration listing the approved fixed structured settlements.

4. The article of claim 1, having further instructions stored thereon that, if executed, enable a computing platform to:
select a next fixed structured settlement;
calculate returns of the next fixed structured settlement income;
calculate a net cash flow of the loan costs, returns of the next fixed structured settlement income and the premium amounts due according to the premium schedule;
if the next fixed structured settlement income is greater than or equal to the loan costs and premiums due according to the premium schedule and payable according to the pay-out schedule on or before the premium schedule due dates, approve the next fixed structured settlement; and
add the approved next fixed structured settlement to a listing of approved fixed structured settlements.

5. The article of claim 4, having further instructions stored thereon that, if executed, enable a computing platform to:
if the next fixed structured settlement income is less than the loan costs and premiums due according to the premium schedule or payable according to the pay-out schedule after the premium schedule due dates, reject the next fixed structured settlement.

6. The article of claim 1, having further instructions stored thereon that, if executed, enable a computing platform to:
adjust the net benefit of the life insurance policy if no fixed structured settlements are approved.

7. The article of claim 1, having further instructions stored thereon that, if executed, enable a computing platform to:
adjust the premium schedule of the life insurance policy if no fixed structured settlements are approved, based at least in part upon the payout schedule of the fixed structured settlements.

8. The article of claim 1, having further instructions stored thereon that, if executed, enable a computing platform to:
adjust the premium portion amount within the premium corridor if no fixed structured settlements are approved, based at least in part upon the income of the fixed structured settlements.

9. The article of claim 1, having further instructions stored thereon that, if executed, enable a computing platform to:
compute a target premium for the life insurance policy, the target premium is greater than a minimum amount of premium required to maintain the insurance policy, the target premium is within the premium corridor and provides cash value growth for the insurance policy; and
set the premium amount at the target premium.

10. The article of claim 1, having further instructions stored thereon that, if executed, enable a computing platform to:
compute a guideline level premium for the life insurance policy, the guideline level premium comprising the maximum amount of the premium corridor range.

11. The article of claim 1, having further instructions stored thereon that, if executed, enable a computing platform to:
compute a 7-Pay Test premium for the life insurance policy, the 7-Pay Test premium comprising the maximum amount of the premium corridor range and qualifies the insurance policy as a non-modified endowment contract.

12. The article of claim 1, having further instructions stored thereon that, if executed, enable a computing platform to:
compute a minimum guarantee premium for the life insurance policy, the minimum guarantee premium is the minimum amount of the premium corridor.

13. A computer-implemented method of funding life insurance premiums comprising:
calculating a premium amount for a life insurance policy and a premium schedule comprising due dates for payment of a portion of the premium amount, using a computing platform having a processor and based at least in part upon data stored in an insurance policy database;
selecting a fixed structured settlement having income paid in fixed installments according to a payout schedule, based at least in part upon data stored in a fixed structured settlement database, the fixed structured settlement comprising an asset that does not fluctuate in amount due to changes in an initial offering rate or market interest rates and/or stock market rates;
calculating loan funds in an amount that is equal to the first premium amount due of the life insurance policy and a purchase price of the fixed structured settlement, using the processor of the computing platform and based at least in part upon data stored in the fixed structured settlement database and insurance policy database;
computing loan costs for the loan funds, using the processor of the computing platform;
calculating a net cash flow of the fixed structured settlement income payouts, the loan costs, and the premiums due according to the premium schedule, using the processor of the computing platform and data from the fixed structured settlement database and the insurance policy database;
if the net cash flow is sufficient to pay the premiums due according o the premium schedule, accepting the fixed structured settlement.

14. The computer-implemented method of claim 13, further comprising:
selecting an insurance policy from the insurance policy database that an insured qualifies for, based upon one or more insured variables, the insured variables stored in an insured database.

15. The computer-implemented method of claim 13 further comprising:
purchasing the accepted fixed structured settlement using the loan funds by sending electronic purchase instructions from the computing platform to a remote computing platform of an owner or servicer of the fixed structured settlement;
paying the fixed structured settlement income to the loan according to the pay-out schedule by sending electronic payment instructions from the computing platform to a remote computing platform of an owner or servicer of the loan; and
paying the portions of the premium amount due according to the premium schedule with the loan funds from the fixed structured settlement income by sending electronic payment instructions from the computing platform to a remote computing platform of the owner or servicer of the life insurance policy.

16. The computer-implemented method of claim 15 further comprising:
paying one or more portions of the premium amount due prior to a due date of the premium schedule or in an amount more than the portion of the premium amount due to create one or more excess cash values for the life insurance policy.

17. The computer-implemented method of claim 15 further comprising:
paying all of said portions of premium due with said fixed structured settlement income until the life insurance policy is paid in full.

18. A financial product comprising:
a life insurance policy having a premium, at least a portion of which is scheduled to be due according to a premium schedule until the policy is fully funded, the premium schedule comprising due dates for paying at least a minimum portion of the premium to maintain the insurance policy, the life insurance policy having a premium corridor comprising a range of maximum and minimum premium amounts due according to the premium schedule so as to qualify the life insurance policy as a non-modified endowment contract product and maintain the insurance policy;
a fixed structured settlement having income payable in a fixed amount according to a pay-out schedule, the pay-out schedule comprising ten years or less, the fixed structured settlement comprising an asset that does not fluctuate in amount due to changes in an initial offering rate or market interest rates and/or stock market rates;
a loan comprising borrowed funds in an amount sufficient to pay a first portion of premium due for the life insurance policy and to pay a purchase cost of the fixed structured settlement;
the fixed structured settlement income is equal to or greater than the life insurance premium due according to the premium schedule, and the pay-out schedule pays the income on or before the premium schedule due dates; and
the fixed structured settlement income is paid to the loan, which then pays the premium due according to the premium schedule due dates.

19. The financial product of claim 18, the premium amount comprising a target premium above the minimum amount of the premium corridor, the target premium providing cash value growth to the life insurance policy.

20. The financial product of claim 18, further comprising a plurality of fixed structured settlements.
